(19) United States
(12) Patent Application Publication
(10) Pub. No.: US 2009/0090606 A1
(43) Pub. Date: Apr. 9, 2009

(54) EMERGENCY STOP DEVICE

(75) Inventor: Yao-Hung LIAO, Taichung Hsien (TW)

Correspondence Address: BROWDY AND NEIMARK, P.L.L.C.;624 NINTH STREET, NW, SUITE 300, WASHINGTON, DC, 20001-5303, US

(73) Assignee: Forhouse Corporation, Daya Township (TW)

(21) Appl. No.: 11/868,131

(22) Filed: Oct. 5, 2007

(51) Int. Cl. H01H 13/00

(52) U.S. Cl. 200/338

(57) ABSTRACT

An emergency stop device includes a first member and a second member. The first member is provided with a magnet and the second member is provided with a screw to be attracted by the magnet for temporary combination of the first member and the second member. The first member is provided with a first sub-circuit and the second member is provided with a second sub-circuit. The first sub-circuit is electrically connected to the second sub-circuit to generate a circuitry when the first member and the second member are combined together. The circuitry will turn to a broken circuitry when the first member and the second member separate.

### BACKGROUND OF THE INVENTION

1. Field of the Invention

The present invention relates generally to a safety device, and more particularly to an emergency stop device.

2. Description of the Related Art

There always is an emergency stop device on a treadmill for user to operate it to stop the treadmill in an emergency.

Typically, a conventional emergency stop device includes a housing, in which a switch is provided, and an insertion. The insertion may be inserted into the housing to turn the switch on, and when the insertion is pulled out, the switch is turned off.

U.S. Pat. No. 7,045,732 disclosed an emergency stop device, which includes a housing, in which a pushing device, a switch module and a spring are provided, and an insertion. The insertion may be inserted into the housing to move the pushing device, and the pushing device will turn the switch on, and when the insertion is pulled out, the spring will move the pushing device back, and the switch is turned off.

These conventional devices may be malfunctioned because of material fatigue or jam of mechanism that the switch couldn't be turned off when the insertion is pulled out, and that will cause danger.

### SUMMARY OF THE INVENTION

The primary objective of the present invention is to provide an emergency stop device, which is sure to be turned off when it is operated.

According to the objective of the present invention, an emergency stop device includes a first member and a second member. The first member is provided with a first sub-circuit and the second member is provided with a second sub-circuit. The first sub-circuit is electrically connected to the second sub-circuit to generate a circuitry when the first member and the second member are combined together. The circuitry will turn to a broken circuitry when the first member and the second member separate.

### BRIEF DESCRIPTION OF THE DRAWINGS

FIG. 1 is a perspective view of the preferred embodiment of the present invention, showing the first member and the second member in combination;

FIG. 2 is a perspective view of the preferred embodiment of the present invention, showing the first member and the second member in separation;

FIG. 3 is an exploded view of a preferred embodiment of the present invention;

FIG. 4 is a sectional view of FIG. 1; and

FIG. 5 is a sectional view of FIG. 2.

### DETAILED DESCRIPTION OF THE INVENTION

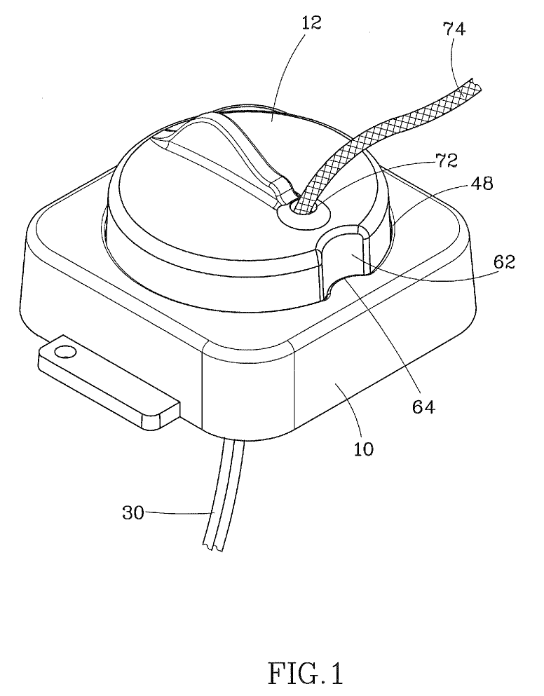

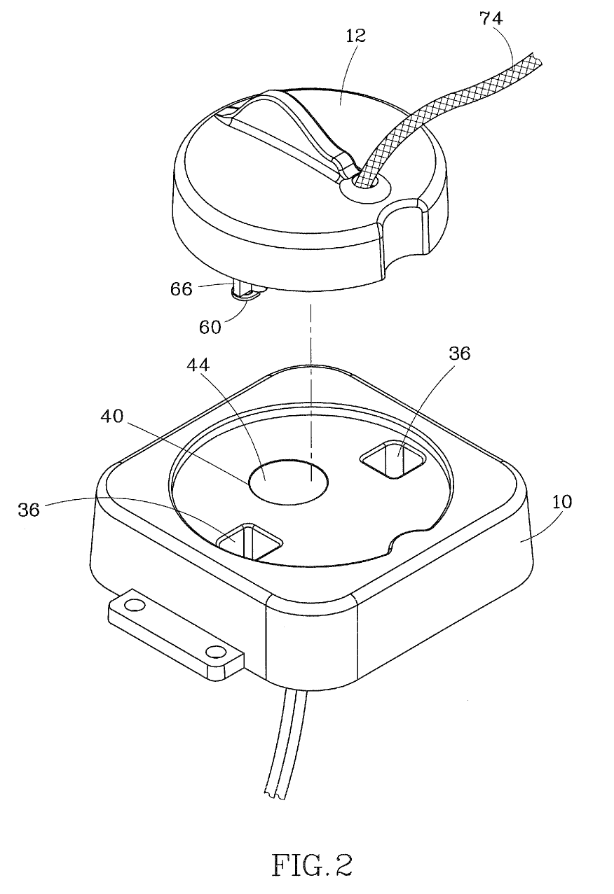

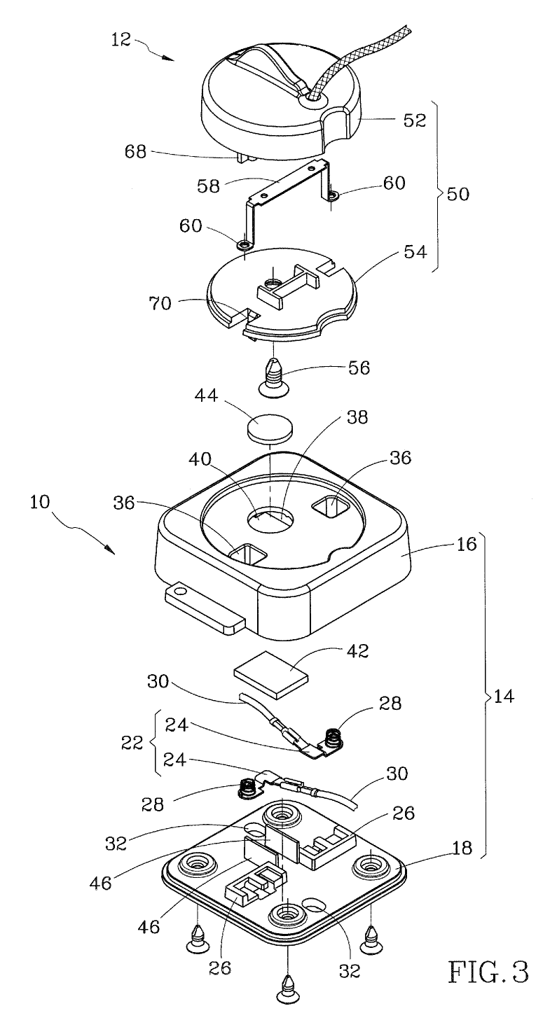

As shown in FIG. 1 to FIG. 3, an emergency stop device of the preferred embodiment of the present invention includes a first member 10 and a second member 12.

The first member 10 includes a housing 14 consisting of a first case 16 and a second case 18 combined together by four screws 20 (only showing 3 screws in drawings). A first sub-circuit 22 is provided in the housing 14 including two metal members 24 fixed to two holders 26 on an interior side of the second case 18, and two springs 28 fixed to the metal members 24 respectively. The springs 28 form terminals of the first sub-circuit 22. The terminals 28 are not in electrical connection. The metal members 24 are connected to wires 30 respectively, and the wires 30 pass through holes 32 on the second case 18 to connect a circuitry of a treadmill or other relative devices. The first case 16 has two inward posts 34 with a hole 36 respectively. The springs 28 are in the holes 36 when the first member 16 and the second member 18 are combined. The first case 16 has a rectangular frame 38 at an interior side thereof and a bore 40 in the frame 38. An iron plate 42, which a size is greater than the bore 40, is received in the frame 38, and a magnet 44 is received in the bore 40 and attracts the iron plate 42. The second case 18 is provided with two support members 46 on the interior side thereof to rest the iron plate 42 thereon when the first member 16 and the second member 18 are combined. The second case 18 has a recess 48 on an exterior side thereof with a shape complementary to the second member 12.

The second member 12, same as the first member 10, includes a housing 50 consisting of a first case 52 and a second case 54 secured by a screw 56 and a second sub-circuit 58 in the housing 50. The second sub-circuit 58 is a U-shaped copper piece with two terminals 60 at opposite ends. The housing 50 has a concave portion 62 to be fitted to a convex portion 64 on a side of the recess 48 of the first member 10. The housing 50 of the second member 12 has two posts 66 consisting of a first post piece 68 on the first case 52 and a second post piece 70 on the second case 54. The copper piece 58 has two sections sandwiched between the first post piece 68 and the second post piece 70, and the terminals are on distal ends of the posts 66. The second member 12 has an opening 72 to fasten a rope 74.

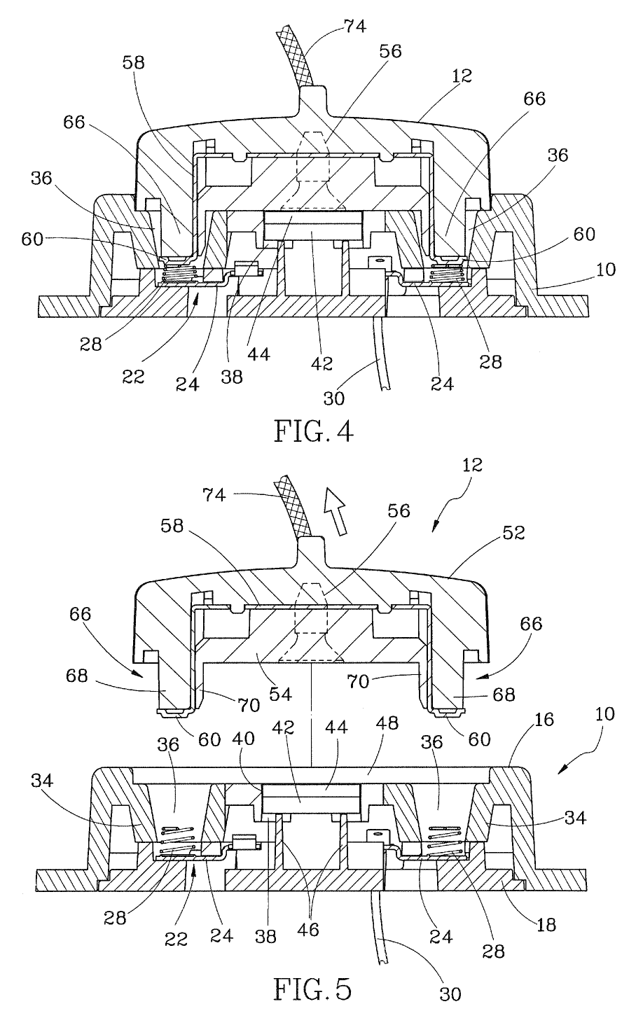

When the second member 12 is put in the recess 48 of the first member 10, referring to FIG. 4, the screw 56 of the second member 12 is attracted by the magnet 44 that the second member 12 is restricted on the first member 10. Besides, the posts 66 of the second member 12 are inserted into the holes 36 of the first member 36 that the terminals 60 of the second sub-circuit 58 touch the terminals 28 of the first sub-circuit 22 to create a circuitry. The circuitry may cause the circuitry of the treadmill in normal operation. The springs 28 of the first sub-circuit 22 may make sure of the terminals 60 of the second sub-circuit 58 in touch with the terminals 28 of the first sub-circuit 22 even when slight vibration or other factors affects the emergency stop device of the present invention. When an emergency or accident occurs, user may pull the rope 74 to separate the second member 12 from the first member 10 that the first sub-circuit 22 and the second sub-circuit 58 are separated to turn the circuitry to a broken circuitry and stop the treadmill.

The circuitry consists of the first sub-circuit 22 of the first member 10 and the second sub-circuit 58 of the second member 12 so that the separation of the first member 10 and the second member 12 may make sure of the circuitry turning to broken circuitry.

What is claimed is:

1. An emergency stop device, comprising:
a first member including a first sub-circuit;
a second member including a second sub-circuit to be detachably combined with the first member; and
means for electrically connecting the second sub-circuit to the first sub-circuit to generate a circuitry when the second member is combined with the first member.

2. The emergency stop device as defined in claim 1, wherein the means include two springs on the first sub-circuit.

3. The emergency stop device as defined in claim 1, wherein the first member has two holes and the first sub-circuit has two terminals under the holes, and the second member has two posts to be inserted into the holes of the first member and the second sub-circuit has two terminals on the posts to touch the terminals of the first sub-circuit when the posts are inserted into the holes.

4. The emergency stop device as defined in claim 3, wherein the each of the posts of the second member includes a first post piece and a second post piece, and the second sub-circuit has two sections sandwiched between the first post pieces and the second post pieces respectively.

5. The emergency stop device as defined in claim 1, wherein the first member is provided with a magnet, and the second member is provided with a member to be attracted by the magnet.

6. The emergency stop device as defined in claim 5, wherein the second member includes a first case and a second case secured together by a screw, and the screw is attracted by the magnet.

7. The emergency stop device as defined in claim 5, wherein the first member is provided with an iron plate attracted by the magnet to secure the magnet on the first member.

8. The emergency stop device as defined in claim 7, wherein the first member is provided with a frame to receive the iron plate therein.

9. The emergency stop device as defined in claim 7, wherein the first member is provided with a support member, on which the iron plate is rested.
